(19) United States
(12) Patent Application Publication
(10) Pub. No.: US 2009/0269991 A1
(43) Pub. Date: Oct. 29, 2009

(54) CONTACT PIN

(75) Inventor: Fei Gao, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/233,596

(22) Filed: Sep. 19, 2008

(30) Foreign Application Priority Data
Apr. 28, 2008 (CN) 200820300635.3

(51) Int. Cl. H01R 13/42

(52) U.S. Cl. 439/751

(57) ABSTRACT

A contact pin is adapted for matching a via in a printed circuit board to generate a reliable electrical connection therebetween, and has a pin body and a contact portion. The contact portion is electrically fixed to the pin body and is bendable to be curved extending from one end of the pin body to the other end thereof. The contact portion is flexible metal material.

### BACKGROUND

1. Field of the Invention

The disclosure relates to contact pins and, specifically, to a contact pin embedded in a via in a printed circuit board (PCB).

2. Description of Related Art

Generally, contact pins are embedded in a via of a printed circuit board (PCB) of an electronic device for electronic testing during experimental production. The contact pin is electrically attached to the PCB via welding. After undergoing welding, the pin is no longer usable and will be discarded, wasting resources and affecting efficiency.

Therefore, it is desirable to provide a reusable contact pin.

### SUMMARY

According to an exemplary embodiment of the disclosure, a contact pin is adapted for matching a via in a printed circuit board to generate a reliable electrical connection therebetween. The contact pin comprises a pin body and a contact portion. The contact portion is electrically fixed to the pin body and bendable to be curved extending from one end of the pin body to the other. The contact portion is flexible metal material.

Other advantages and novel features will become more apparent from the following detailed description when taken in conjunction with the accompanying drawings, in which:

### BRIEF DESCRIPTION OF THE DRAWINGS

FIG. 1 is a perspective view of a contact pin in accordance with an exemplary embodiment;

FIG. 2 is a front view of the contact pin of FIG. 1; and

FIG. 3 is a perspective view of a plurality of contact pins of FIG. 1 embedded in a PCB.

### DETAILED DESCRIPTION OF THE EMBODIMENTS

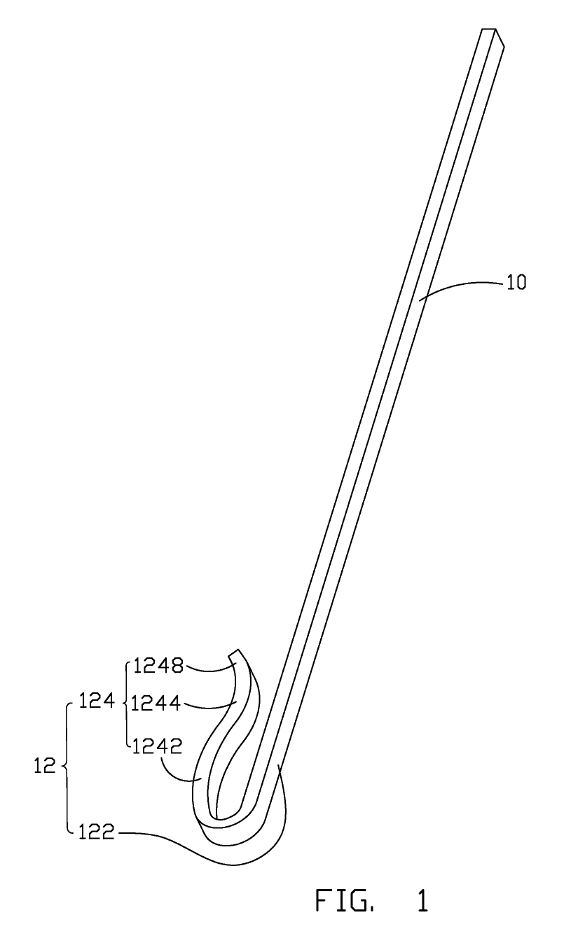

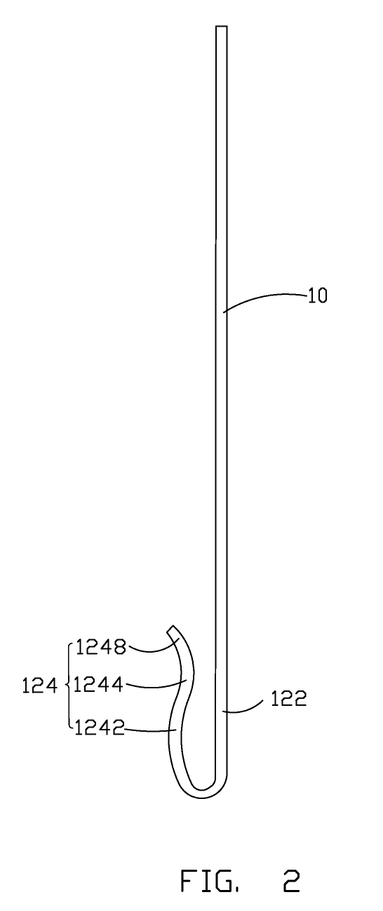

Referring to FIG. 1 and FIG. 2, a contact pin comprises a pin body 10 in a slim shape and a contact portion 12 electrically fixed thereto. The contact portion 12 is bendable to be curved extending from one end of the pin body 10 to the other end thereof. In this embodiment, the contact portion 12 is integrally formed with the pin body 10. The contact pin, having a rectangular cross section, is flexible metal material.

The contact portion 12 comprises a connecting part 122 and a curved part 124. One end of the connecting part 122 is connected to one end of the pin body 10, and the curved part 124 is connected to the other end of the connecting part 122. The connecting part 122 and the pin body 10 collectively configure a linear profile. The curved part 124 extends from the other end of the connecting part 122 towards the pin body 10, forming an S shape.

The curved part 124 comprises a first protrusion 1242, a recessed portion 1244 and a second protrusion 1248, connected in turn. The recessed portion 1244 extends between the first protrusion 1242 and the second protrusion 1248. The first protrusion 1242 extends between the first side 122 and the recessed portion 1244. The first protrusion 1242, the recessed portion 1244, and the second protrusion 1248 are on the same side of the connecting part 122. Compared with the first protrusion 1242 and the second protrusion 1248, the recessed portion 1244 is further adjacent to the connecting part 122, that is to say, a distance between the recessed portion 1244 and the connecting part 122 is less than that between the first protrusion 1242 or the second protrusion 1248 and the connecting part 122.

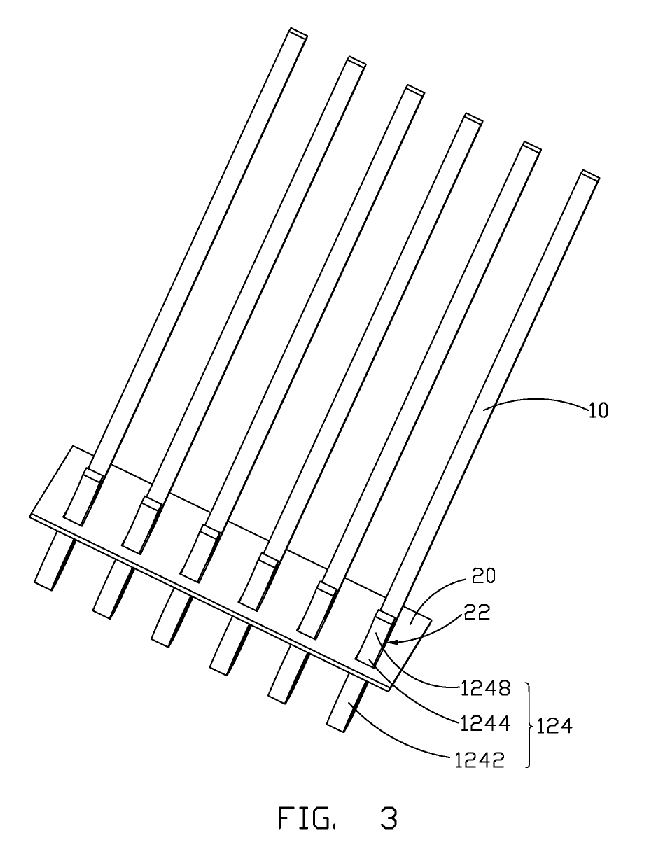

Referring to FIG. 3, the contact portion 12 of the contact pin embedded in a via 22 of a PCB 20 is electrically connected to the via 22 due to elastic properties thereof. The recessed portion 1244 contacts the PCB 20. When the contact pin is not embedded in the PCB, the distance between the recessed portion 1244 and the connecting part 122 exceeds a maximum diameter of the via 22. The contact pin thus exhibits sufficient elasticity to generate a reliable connection between the contact portion 12 and the PCB 20. A section of the via 22 of the PCB 20 may be circular, elliptical, or rectangular, among other shapes. The pin body 10 has a section the same shape as the via 22 correspondingly.

The first protrusion 1242 and the second protrusion 1248 are on two sides of the PCB 20, such that the contact pin can easily be removed and reused.

In other embodiments, the contact portion 12 can be connected to the pin body 10 via welding or other electrical connection methods.

While exemplary embodiments have been described above, it should be understood that they have been presented by way of example only and not by way of limitation. Thus, the breadth and scope of the disclosure should not be limited by the above-described exemplary embodiments, but should be defined only in accordance with the following claims and their equivalents.

What is claimed is:

1. A contact pin adapted for matching a via in a printed circuit board to generate a reliable electrical connection therebetween, the contact pin comprising:
a pin body; and
a contact portion electrically fixed to the pin body and bendable to be curved extending from one end of the pin body to the other end thereof;
wherein the contact portion is flexible metal material.

2. The contact pin as claimed in claim 1, wherein the contact portion comprises a connecting part with one end connected to one end of the pin body and a curved part connected to the other end of the connecting part.

3. The contact pin as claimed in claim 2, wherein the curved part extends from the other end of the connecting part towards the pin body.

4. The contact pin as claimed in claim 2, wherein the curved part comprises a first protrusion, a recessed portion and a second protrusion, connected in turn.

5. The contact pin as claimed in claim 4, wherein the recessed portion is further adjacent to the connecting part compared with the first protrusion and the second protrusion.

6. The contact pin as claimed in claim 4, wherein the curved part is S-shaped.
